(19) United States
(12) Patent Application Publication
(10) Pub. No.: US 2003/0137730 A1
(43) Pub. Date: Jul. 24, 2003

(54) Autostereoscopic display

(76) Inventors: Sergey Fridman, Monterey, CA (US); Vladimir Fridman, Monterey, CA (US)

Correspondence Address: VLADIMIR FRIDMAN, 905 FILMORE ST., MONTEREY, CA, 93940, US

(21) Appl. No.: 09/683,587

(22) Filed: Jan. 23, 2002

(51) Int. Cl. G02B 27/22

(52) U.S. Cl. 359/462; 359/463

(57) ABSTRACT

An autostereoscopic display apparatus broadly comprises of backlighting means for projecting light, a spatial light modulator for modulating light emanated by the backlighting means, lens array comprising of plurality of lenses and an optional aperture screen for blocking unwanted light. The aperture screen is used to select only those rays from the backlighting means that have a predetermined direction. For instance rays orthogonal to the plane of the spatial light modulator. If the backlighting means are such that the emitted light has a predetermined direction then the aperture screen may be avoided. The spatial light modulator modulates light assuming that it only comprises of rays that have a predetermined direction. Each lens of the lens array translates spatially modulated light into directionally modulated light so that the directional distribution of light at each point of the array approximates the light emanating from the three-dimensional scenery to be reproduced. Preferably each lens is a converging lens so that it collects the light near its focal point. Individual apertures of the aperture screen coincide with focal spots of the lens array and select only the light that focused at those focal spots. Each aperture emits directionally modulated light where light intensity at every direction can be controlled by the spatial light modulator. Plurality of apertures comprises the three-dimensional picture visible on the autostereoscopic display.

### BACKGROUND OF THE INVENTION

References Cited

U.S. PATENT DOCUMENTS

U.S. Pat. No. 3,503,315 March 1970 de Montebello . . . 396/330

U.S. Pat. No. 3,535,993 October 1970 Jones . . . 396/330

U.S. Pat. No. 4,621,897 November 1986 Bonnet . . . 359/462

U.S. Pat. No. 4,649,425 March 1987 Pund . . . 348/52

U.S. Pat. No. 5,083,199 January 1992 Borner . . . 348/59

U.S. Pat. No. 5,099,320 March 1992 Allio . . . 348/59

U.S. Pat. No. 5,132,839 June 1992 Travis . . . 359/462

U.S. Pat. No. 5,349,379 September 1994 Eichenlaub . . . 348/59

U.S. Pat. No. 6,233,035 March 2001 Toshiyuki . . . 355/22

OTHER PUBLICATIONS

“Three-Dimensional Imaging Techniques”, Takanori Okoshi, Academic Press, 1976

“An Autostereoscopic Display”, Ken Perlin et al., SIGGRAPH 2000 Proceedings pp.319-326

The invention described herein originates from the autostereoscopic image capture and reproduction method called Integral Photography. The term autostereoscopic refers to stereoscopic images that can be viewed without use of any additional equipment by the observer such as special glasses. In a conventional two-dimensional image there are usually several psychological cues presented to the observer that provide the perception of depth. These cues include object size, shadow, linear perspective and object overlapping. However, a two-dimensional is unable to provide any physiological cues and thus cannot provide a true perception of depth.

The physiological cues are summarized in Okoshi″s book (Okoshi, 1976) and they are: accommodation, convergence, binocular parallax and monocular movement parallax. Accommodation is a cue given by the adjustment of the focal length of the eye's crystalline lens when an eye focuses on a particular object. Convergence is a cue given by the angle made by the two viewing axes of observer's eyes. Binocular parallax is a cue caused by the difference between the views seen by the two eyes of an observer. Monocular movement parallax is a cue observed when a person is moving and is caused by the changing view in each of the person's eyes. Accommodation and monocular parallax are available even when we see an object with a single eye.

There are several stereoscopic techniques that provide at least one of the physiological depth cues. Binocular stereoscopic technique is based on the idea that when two slightly different images are provided to two eyes of an observer then the binocular parallax will be observed. However this technique does not provide any of the other three physiological cues.

Holography is a technique that reproduces all four physiological cues. Unfortunately, it is very difficult to generate and produce a synthetic hologram because a very fine interference pattern needs to be computed and reproduced. This makes it difficult to implement an autostereoscopic display based on the holography principle. Another disadvantage of the holography approach is that it records and reproduces a monochromatic light, thus the reproduced image has one dominant color.

OLE_LINK3Another stereoscopic image reproduction method is called parallax barrier technique. This method is based on the idea of showing different images on a display through a blocking barrier that has only one vertical slit open at a time. Each open slit has certain image shown through it. This technique, however, reduces display resolution and results in a low light display since the parallax barrier blocks most of the light.

A lot of efforts were made trying to create a stereoscopic display based on above techniques in combination with head tracking methods. Eye tracking was part of the invention of a binocular screen that does not require any special glasses in the U.S. Pat. No. 5,349,379. Eye tracking also allowed other researchers to optimize parallax barrier display. However, the disadvantages shown above still remain for every said type of the stereoscopic display.

Integral Photography is a method that like holography provides all four physiological depth cues. However images displayed using Integral Photography method are much easer to generate and to reproduce than hologram interference patterns. Lippmann originally envisioned the concept of Integral Photography. Lippman's research is described in detail in Academe des Sciences, Comptes Rendus, 146, 1908, pp 446-451, and in the March 1932 Journal of the Optical Society of America, vol. 21, pp. 171-176. The autostereoscopic display employing cellular elements was envisioned as a device for presentation of integral photographs, which were supposed to exhibit full stereoscopic effect. Lippmann's theoretical suggestions however turned out to exhibit some fundamental problems when efforts were made to implement the concept by other researchers. Most importantly, the image as seen by the observer appeared pseudoscopic, having a reversed depth.

In 1950's research on Integral Photography by Roger de Montebello lead to new inventions that helped eliminate the pseudoscopic effect by geometrically reorienting elemental images. However some problems still remained. Among these problems are the limit of the image depth that could be provided without blurring, the relatively expensive process of making lens arrays, the problem of lens aberrations, the reflection of light from the lens array that causes the observer to focus his or her eyes on the plane of the display instead of the virtual image behind the screen and thus making it difficult to observe the stereoscopic effect.

Research in this field later led to inventions of various displays based on the same principle of Integral Photography such as CRT and LCD autostereoscopic displays. All of these inventions however either exhibited same problems as de Montebello's device or proposed means to correct these problems, which were not technically possible or were not commercially feasible.

### SUMMARY OF THE INVENTION

It is a an object of the invention to provide a display apparatus for showing still or motion pictures that exhibit four physiological depth cues, which are accommodation, convergence, binocular parallax and monocular movement parallax. Such apparatus as used herein will be called the “autostereoscopic display”.

It is a further object of the invention to provide an autostereoscopic display that does not require use of any equipment by the viewer such as special spectacles.

It is another object of the invention to provide an autostereoscopic display that can be used by unlimited number of viewers concurrently.

It is yet another object of the invention to provide a practical and efficient autostereoscopic display system, which utilizes no moving parts.

It is even a further object of the invention to provide an autostereoscopic display that does not require any knowledge as to the location of the viewer or viewers.

It is even a further object of the invention to provide an autostereoscopic display, which is not time multiplexed. This means that reproduction of a still autostereoscopic image does not require any changes in the display system.

In accordance with the objects of the invention, a stereoscopic display apparatus broadly comprises of backlighting means for projecting light, a spatial light modulator for modulating light emanated by the backlighting means, lens array comprising of plurality of lenses and an optional aperture screen for blocking unwanted light. The aperture screen is used with arrays of converging lenses as a device for selecting only those rays from the backlighting means that have a predetermined direction before entering the spatial light modulator. Rays having said predetermined direction are modulated by the spatial light modulator and then refracted by lenses of the lens array. Individual lenses translate spatial modulation of the spatial light modulator into directional modulation by refracting the incoming rays. Also each lens collects all rays with said predetermined direction at focal point. Individual apertures are placed at the focal points of lenses and block any unwanted light.

To maximize effectiveness of the backlighting means all rays emitted by the backlighting means should have the predetermined direction. For instance the backlighting means can be a collimated light source with all rays orthogonal to the surface of the spatial light modulator and the lens array.

The invention is particularly applicable as a new method for displaying modulating photograms. The term “modulating photogram” as used herein means a photographic or artificially generated record of an optical field in which the record consists of multiplicity of independent and non-overlapping minute, elemental images displayed on a transparent medium each of which is a projection of a large portion of the field. The main purpose of the modulating photogram is to capture a light field that exists in a certain bounded window in space. This involves light wavelength and irradiance at all points and in all directions in that window as long as light direction is within modulating photogram's field of view. The display of the modulating photogram should approximate the light field captured on it and hence the observer should see the captured scene in three-dimensions.

The meaning of the term “modulating photogram” differs from the term “photogram” that is used in relation to integral photography and as defined in U.S. Pat. No. 3,503,315. While traditional photogram usually consists of elemental images each of which is a perspective projection of some three dimensional scene, the modulating photogram may consist of images that are not necessarily a perspective projection of the scene. Projection may be different and not necessarily linear for backlighting means other than collimated light and for lens arrays that are characterized by substantial aberrations. Some methods of taking modulating photograms using special photographic equipment were described in the prior art and are not objects of this invention. A method of artificially generating a modulating photogram, for example using computers in modeling and displaying of virtual objects will be described in the details of the invention. A controlled spatial light modulator such as a liquid crystal display can be used to realize the modulating photograms.

Preferred embodiment of the invention shown on FIG. 1 consists of a collimated light source, a spatial light modulator, lens array and aperture screen. Improvements to the prior art presented in the invention can be divided into three categories.

The first category introduces a new way of illuminating spatial light modulator. Specifically the spatial light modulator is illuminated by light that is not diffuse as in the prior art. Instead the light should have a predetermined direction of rays that comprise it such as collimated light or light from a point source. The lens array is made to work with a specific light type and must focus it at a predetermined surface where the aperture screen will be placed. The most intuitive embodiment of this invention would consist of the parallel light source that emanates light in the direction orthogonal to the plane of the modulating photogram as well as to the plane of the lens array. A modulating photogram does not have to be in focus of the lens array and in theory could be at any distance from it along the line that is normal to the lens array. This invention when implemented eliminates most of the lens aberration problems characteristic to the traditional integral photography display.

The second part of the invention introduces a new way of eliminating the problem of reflected and scattered light from the front of the lens array. This part also introduces a way of selecting only light that falls on the spatial light modulator with a predetermined direction of rays even if the light from the backlighting means exhibit some diffuse properties. An opaque screen is placed in front of the array at the distance that is equal to exactly one focal length of the lens array. The screen having apertures that coincide with the focal points of individual lenses passes only light modulated by the spatial light modulator and focused by the lens array and only the light that has a predetermined direction of rays at the spatial light modulator. The aperture screen absorbs most of parasite light.

The third part of this invention deals with the new type of lens array that could be used to produce autostereoscopic image. Since all that is required of the lens array is to focus the incident light that has predetermined direction of rays that comprise it then lenses could be Fresnel or diffraction lenses. This relieves many restrictions on the part of the quality of individual lenses in the lens array, thus the process of producing lens arrays is likely to become cheaper. This also allows usage of lenses with very short focal distance, which increases autostereoscopic display's field of view and adheres to more compact design.

### BRIEF DESCRIPTION OF THE DRAWINGS

FIG. 1 is a perspective view of the preferred autostereoscopic display embodiment in accordance with the invention.

FIG. 2 is a magnified view of one part of the preferred embodiment that contains one lens, one aperture and a part of the spatial-light modulator.

FIG. 3 is a cross sectional view of a part of the preferred embodiment of the invention. A ray diagram shows how the apparatus displays a virtual object.

FIG. 4 is a diagrammatic section through the first embodiment of a collimated light source used in the preferred embodiment of the invention.

FIG. 5 is a diagrammatic section through a second embodiment of a collimated light source used in the preferred embodiment of the invention.

FIG. 6 is a diagrammatic section through a third embodiment of a collimated light source used in the preferred embodiment of the invention.

FIG. 7 is a diagrammatic section through a part of the preferred embodiment of the invention that illustrates how cylindrical aperture diameter should be calculated.

FIG. 8 is a diagrammatic section through a second embodiment of the autostereoscopic display apparatus where the back lighting means is a point light source.

FIG. 9 is a diagrammatic section through a third embodiment of the autostereoscopic display apparatus where the back lighting means is an array of point light sources.

### DETAILED DESCRIPTION OF THE INVENTION

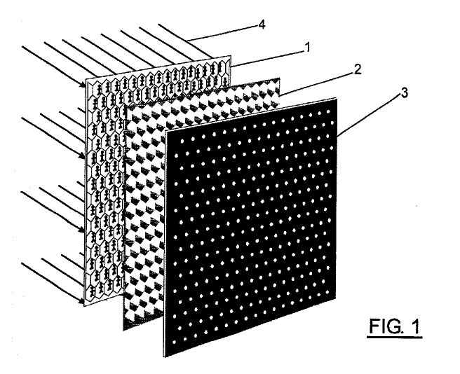

Referring to FIG. 1, the preferred embodiment of an autostereoscopic display apparatus comprises of a spatial light modulator 1 that is illuminated with collimated light 4, lens array 2 and the aperture screen 3. This apparatus is used to recreate a light field that would be a good approximation to the light field from a three-dimensional scene. The modulating photogram is displayed by means of the spatial light modulator. An opaque box is preferably fitted around the rear and the sides of the autostereoscopic display apparatus to exclude extraneous light.

The term “spatial light modulator” as defined herein means a devise whose optical transparency and color at different points can be controlled. The most primitive example of a spatial light modulator is a slide or a picture printed on a peace of plain transparent material. Another example of a spatial light modulator is a liquid crystal display (LCD).

As shown, there is provided a lens-array 2, preferably of a transparent, uncolored plastic material formed as a closely packed network of small uniform elements. Each element should collect the incoming parallel light at a focal point in front of the lens-array. Elements could be conventional lenses, however since elements do not have to deal with the light incident from any direction other than orthogonal to the plane of the lens-array, they could be Fresnel or diffraction lenses. The packing of lenses is preferably hexagonal or honeycomb pattern, as shown on FIG. 1, but could be any other arrangement, such as square or triangular. The lens array can also be replaced with a lenticular screen comprising of plurality cylindrical lenses placed next to each other in the horizontal direction.

A modulating photogram as defined above is realized on a spatial light modulator and consists of multiplicity of independent and non-overlapping elemental images. In order to maximize the field of view each elemental image is desirable to be of the same shape and size as each element of the lens-array. In addition, the plane of the modulating photogram should be parallel to the plane of the lens array and each elemental image should be coinciding with exactly one lens of the lens-array. This arrangement ensures that any light ray orthogonal to the plane of the modulating photogram is going through one image element of the modulating photogram and one lens of the lens-array. In reality, however, the light can deflect from the spatial light modulator due to diffusing nature of the comprising material or due to light diffraction effect. To minimize both of these problems it is preferred that the spatial light modulator is placed right next to the lens-array with the minimum of space between them.

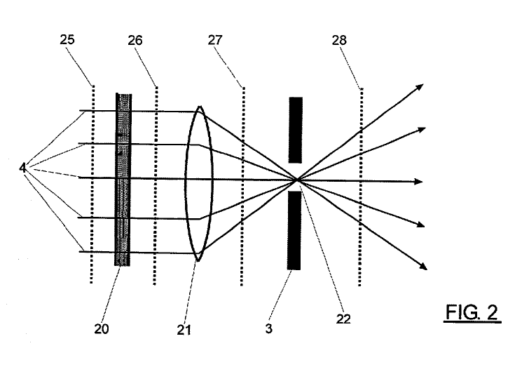

As shown on FIG. 2, each elemental image 30 of the modulating photogram realized on the spatial light modulator depicts a portion of light field as seen through the window bounded by said elemental image from the point that is situated on the corresponding lens axis one focal distance away from the elemental image. Said focal distance is the focal distance of the corresponding lens of a lens array. The purpose of each elemental image is to reproduce light irradiance and wavelength for all directions within the display's field of view. However, each elemental image by itself does not reproduce the direction of the light. Lenses of the lens array placed next to the spatial light modulator reconstruct the light direction.

The light emitted from the parallel light source is transmitted through the spatial light modulator, and then collected by each lens of the lens array at the focal point of each lens. The aperture screen is placed one focal distance from the lens array and aperture centers coincide with lens array's focal points. The light coming out of each aperture in the aperture screen will have the same irradiance and wavelength for all directions within the display's field of view as the light that would have gone through same points had there been a real scene to the left of the aperture screen. The viewer observing the display will thus observe the scene that was used to create the modulating photogram and will be able to view it from any direction provided he or she stays within display's field of view. Therefore the stereoscopic effect will be observed.

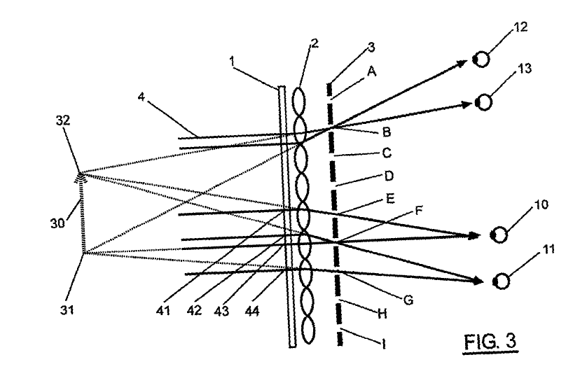

By way of additional explanation, reference is had to FIG. 3, which shows the setup used in a preferred embodiment of the invention. FIG. 3 and other figures are not drawn to scale and are provided purely for illustrative purposes for easier description of the invention. It is a principle of optics that the source of any ray can be found by reversing the direction of the ray and tracing it through the optics back to the source. As shown in FIG. 2 two eyes of an observer 10 and 11 are observing a static virtual object 30 through the plane of the aperture screen 3. Individual apertures are lettered A, B, C, . . . I. Each aperture represents a unique point on the screen surface of an autostereoscopic display. Each said point or aperture emits light of different irradiance and color content for different directions. The eye 10 looking in the direction of point E sees the top 32 of the virtual image 30. As can be seen from the FIG. 3 the information about this virtual point, consisting of color, irradiance and direction, is reproduced from a point 41 on the spatial light modulator.

Similarly, the same eye looking in the direction of the aperture F of the autostereoscopic display sees the bottom 31 of the virtual object 30. The information for the given direction about the virtual point 31 is reproduced from the point 43 on the spatial light modulator. Following the same analysis it can be shown that the eye 11 sees the top 32 of the virtual object 30 through aperture F. This information is reproduced from the point 42 on the spatial light modulator. Also the same eye 11 sees the bottom 31 of the virtual object 30 through aperture G. This information is reproduced from the point 44 on the spatial light modulator.

Suppose the observer moves to a different location and looks at the autostereoscopic display with two eyes placed as 12 and 13 on the FIG. 2. The two eyes will observe different points from the aperture B. Specifically the eye 13 will see the top 32 of the virtual object 30, while the eye 12 will observer the bottom 31 of the same virtual object 30.

As it can be seen from the FIG. 2 the eyes 10 and 11 observe different views. Therefore the binocular parallax depth perception cue is reproduced by the given autostereoscopic display. Furthermore, as it is seen from FIG. 2 whenever the observer moves around, the static virtual image used in the diagram stays at the same location behind the screen. Thus the monocular movement parallax is exhibited by the presented display. On another hand, when the eyes 10 and 11 are focused on the same virtual point 32 then the viewing axis of the two eyes will lye along the lines connecting corresponding eye with the virtual point 32. Therefore, there is an angle between the two viewing axis of observer's eyes and the convergence depth cue is perceived. Similarly, a virtual point (not shown) that is a little closer than 32 to the observer's eyes 10 and 11 will appear out of focus when the eyes are focused on the point 32. Thus accommodation depth cue is exhibited by the presented autostereoscopic display.

FIG. 2 shows a large-scale view of part of the autostereoscopic display apparatus. It shows one lens 21, an aperture 22 and part of the spatial light modulator 20 that presumably displays one elemental image of a modulating photogram. There are four stages 25, 26, 27 and 28 that the light from the back lighting means travels through. Stage 25 is a stage where in the preferred embodiment of the invention the light 4 is collimated and no information is reconstructed. Light passes through the spatial light modulator and reaches the stage 26 where light color and intensity for the point in the center of the aperture 22 is reconstructed. Then the lens 21 refracts the light giving every ray the proper direction and the light reaches stage 27. At this stage the spatial modulation is translated into directional modulation for the point in the center of the aperture 22 and distribution of color and intensity for the said point is reconstructed. The aperture 22 in the aperture screen 3 blocks scattered, reflected and other unwanted light and passes only the light that contains information reconstructed about the virtual scene. When the light reaches the stage 28 all distribution of light for the point in the center of the aperture 22 has been reconstructed. An individual aperture 22 can be thought of as a point on a screen of the autostereoscopic display 6.

The first important part of the invention is the realization that the spatial light modulator and the lens array should only deal with light rays with predetermined direction at all points on the surface of the spatial light modulator. Preferably the backlighting means should emit a non-diffused light, for instance collimated light. This fact together with close arrangement of the modulating photogram and the lens array eliminates the problem of lens aberration and blurring typical to the conventional Integral Photography. In the conventional Integral Photography the is placed somewhere close to the plane formed by focal points of the lens-array. The method relies on the approximation that parallel light incident on an arbitrary lens at any angle would focus on the focal plane. In reality the focal plane does not exist doe to lens aberrations that are commonly present in lenses with short focal distance. Hence there arises a blurring problem. When parallel light is used to backlit the modulating photogram the blurring problem is no longer present, since all that is required of any lens is to focus parallel light. Lenses in the present invention do not have to focus light incident from any direction other than the predetermined direction of the back lighting beam. In the preferred embodiment of the invention this direction is orthogonal to the plane of the lens array. This leads to another important part of the present invention: relieved requirements on functionality of lens array. Namely, the only requirement is the ability to focus light that has a predetermined direction. This allows usage of Fresnel lenses or diffraction lenses in the lens-array. These lenses have many advantages compared to conventional lenses. They are usually cheaper to produce and hence may reduce the total cost of the autostereoscopic display production. Fresnel lenses are thinner and therefore cause less chromatiacal aberrations. Another important advantage of Fresnel and diffraction lenses is that it is possible to create lenses with a very short focal distance. The shorter the focal distance is the large the autostereoscopic display's field of view becomes. Conventional lenses with a very short focal distance have large aberrations and thus can not be used effectively. Fresnel lens array, however, can have a very short focal distance without introducing any substantial aberrations in focusing incident light that has a predetermined direction.

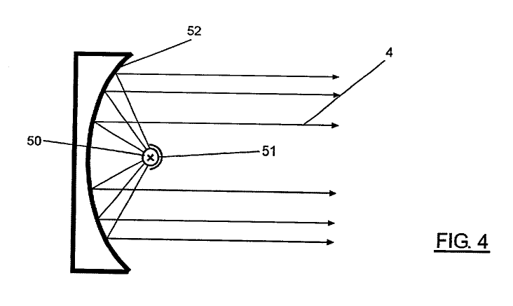

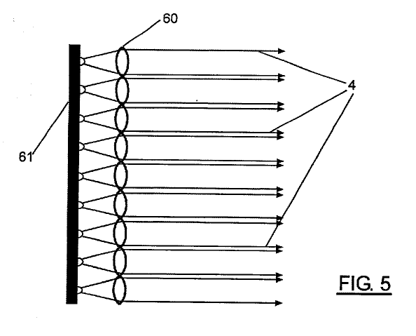

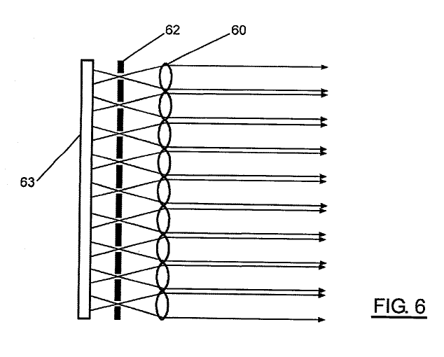

Parallel light source could be constructed in a variety of different ways. One possible embodiment of the parallel light source could be as depicted on the FIG. 4. The light bulb 50 covered with an opaque shield 51 is placed in the center of a concave mirror 52. The light bulb 50 emanates light uniformly in all directions and the mirror 52 reflects this light turning it into a parallel light beam 4. Another possible embodiment is depicted on the FIG. 5. It consists of a lens-array 60 and an array of light emitting diodes (LED) 61. Diodes are placed at the focal points of lenses and act as a close approximation to point light sources. Lens array turns light from LEDs into parallel light. An aperture screen 62 and a bright diffuse light source 63 behind that screen as depicted on FIG. 6 could replace LED array of the previous embodiment. Yet another embodiment of the parallel light source could be a laser beam with cross sectional dimensions same as dimensions of the modulating photogram.

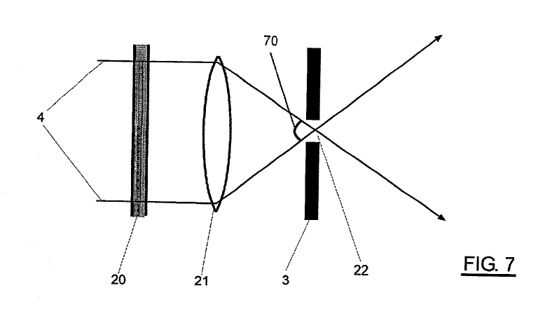

The method for showing photograms as described in de Montebello's method exhibits strong reflection from the lens-array. This problem makes it difficult for an observer to focus on the virtual image behind the screen because the reflected light intensity could mask the light that forms the virtual image. An opaque aperture screen introduced in this invention diminishes this problem to the point where it is no longer relevant. Given that apertures are sufficiently small the light that goes through them is only the light that was recorded on the modulating photogram, there is practically no reflection light. This makes it easy for a person in front of the screen to observe a virtual scene. It is preferred that the aperture screen is made out of opaque material such as a thin plastic or metallic panel of a black matte color. Apertures should be made as small as possible. However, apertures″ shape and size should ensure that blocking of the light to be focused is negligible. In the preferred embodiment of the invention apertures should not block any light that was emanated by the collimated light source and then refracted by lenses of a lens array. An example depicted on FIG. 7 illustrates calculations of a cylindrical aperture's diameter. As can be seen there is provided a lens 21 that has field of view 70 equal to 45 degrees and the width of the aperture screen panel 3 is 1 mm. In order for the aperture not to block any light coming out of the lens the minimum diameter of the aperture 22 should be 1 mm.

Another advantage of using the aperture screen is that it allows for the backlighting means to have some diffuse light properties without seriously compromising the three-dimensional image reproduced on the display. The aperture screen serves as a device for selecting only light rays with predetermined direction that are focused at the center of each aperture. However, the more diffuse the light from the backlighting means the greater there is a chance of unwanted artifacts appearing on the display. Also diffuse light is less effective because only small portion of it passes through the aperture screen and can be seen by an observer. A modulating photogram shown on the spatial light modulator could be a photograph of a real scene taken using one of the methods of taking photograms described in the prior art. A modulating photogram could also be an image synthesized on a computer using computer graphics techniques. By way of additional explanation, a method for synthesizing a modulating photogram on a computer for the preferred embodiment of the invention will be described.

A modulating photogram in the preferred embodiment of the invention is a collection of elemental images, where each elemental image is a perspective projection of a scene onto the surface of the modulating photogram. In order to maximize the field of view the size and shape of each elemental image should be the same as the shape and size of a lens through which said elemental image is going to be displayed. The angle of view used in generation of perspective projection should be the same as the angle of view of the lens through which this image is going to be shown. Furthermore, when synthesizing the perspective projection the virtual camera location should be on the corresponding lens axis at a distance one focal length away from the plane of the elemental image.

This setup can be thought of as a collection of virtual cameras that are placed at aperture center points of the aperture screen and that are looking through windows bounded by lens borders of the lens array. Cameras are projecting the synthesized scene on the plane of the lens array.

So far it has been described how to synthesize virtual scene where all objects are placed behind the plane of the aperture screen. However, objects can also be placed in front of the aperture screen and hence in front of the autostereoscopic display. This can be accomplished taking into account the fact that if every elemental image of a modulating photogram is geometrically reoriented, more specifically if every image is flipped horizontally and vertically, then objects in the scene will appear before the aperture screen as part of a pseudoscopic image. Using this effect a scene can be modified to contain pseudoscopic images of objects. Then when a modulating photogram is synthesized and each elemental image is geometrically reoriented as described above then objects will appear in front of the screen as part of an orthoscopic image.

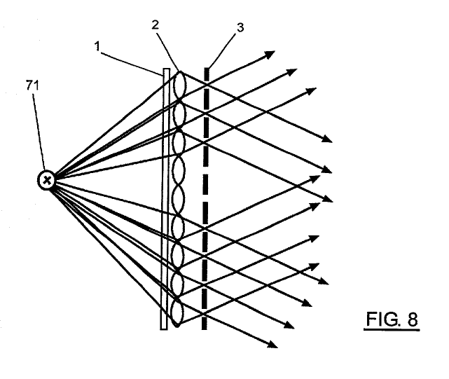

The preferred embodiment of the invention described above uses a collimated light source. However, an alternative embodiment could use a point light source 71 by using custom made Fresnel lens array 2 that collects light from the light source 71 and focuses it at centers of apertures in the aperture screen 3 in the same way as a lens-array focuses light for the case of parallel light source. Such embodiment is shown on FIG. 8. In this alternative embodiment of the invention the modulating photogram displayed on the spatial light modulator 1 should be different than the modulating photogram used in the collimated light source. The following condition should still hold. Every ray emitted by the point light source should cross one elemental image on the modulating photogram and one lens on the lens array.

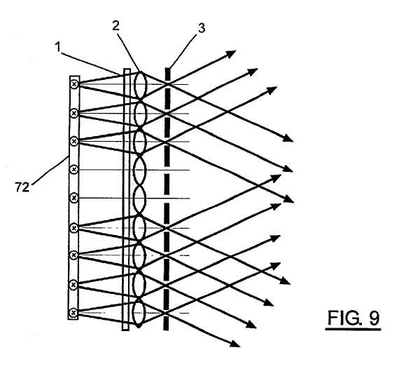

The third embodiment of the invention is shown on FIG. 9 and uses an array of point light sources 72 as the back lighting means. In this embodiment there is one point light source for every lens of the lens array. Every point light source of the array is placed on the corresponding lens axis in front of the spatial light modulator.

Other alternative embodiments of this invention could use a different light source or a collection of such. The property that unites all such embodiments is that the light has a predetermined direction at every point before entering the modulating photogram and thus it is not a diffused light. The lenses should be made in accordance with the position and nature of the light source for every embodiment of this invention. Spatial light modulator should modulate light according with the placement and arrangements of lenses and in accordance with the incident light from a non-diffused light source.

One of the important advantages of the invention over prior art is the fact that the autostereoscopic display apparatus is not time multiplexed. Those skilled in the art are familiar with an approach where back lighting beam changes direction with time and passes through a spatial time modulator. Thus light intensity and color are shown for each different direction at different times. Such approach has been called time multiplexed. However, said method requires spatial light modulator to function at a very high frequency since there can be a very large number of directions for which the light has to be modulated. In addition, in order to avoid flickering, the full modulation cycle through all directions has to happen around 24 times a second. This means that such apparatus reproducing 100 different directions has to have a spatial light modulator that works at a frequency around 2.5 kHz for reproduction of a static stereoscopic picture. Such devices are very expensive to produce if at all possible.

The present invention introduces a device that is not time multiplexed. No changes in the system are required to show a single static three-dimensional image. To produce motion autostereoscopic picture the spatial light modulator has to modulate light differently at the rate at least 24 times a second. This means that the spatial light modulator has to work at a normal frequency of 24-80 Hz. Such frequency eliminates any flickering. A readily available liquid crystal display can be used in the system.

1. An autostereoscopic display apparatus for displaying a subject in still or motion picture, said display comprising of:
a) A backlighting means for projecting light in a form of a non-diffuse light source that emanates light rays that have a predetermined direction at every point on the surface of the spatial light modulator.
b) A spatial light modulator for modulating the light originated from the back lighting means. For the motion picture display case the spatial light modulator modulates light differently at different points in time, which causes motion three-dimensional picture to appear on the autostereoscopic display.
c) A lens array comprising of plurality of elemental lenses.

2. An autostereoscopic display apparatus for displaying a subject in still or motion picture, said display comprising of:
a) A backlighting means for projecting light. To maximize the effectiveness of the backlighting means it should be a non-diffuse light source that emanates light rays that never intersect on the surface of the spatial light modulator. However, it is not required to be such a light source.
b) A spatial light modulator for modulating the light originated from the back lighting means. For the motion picture display case the spatial light modulator modulates light differently at different points in time, which causes motion three-dimensional picture to appear on the autostereoscopic display.
c) A lens array comprising of plurality of elemental lenses wherein every element of the lens array is behaving as a converging lens.
d) An aperture screen placed in front of the lens array. Said aperture screen comprising of an opaque material with plurality of apertures. Said apertures coincide with spots where the light emitted from the said light source is focused by each elemental lens of the lens array.

3. An autostereoscopic display apparatus according to claim 1, wherein:
Said lens array comprises of plurality of elemental lenses wherein every element of the lens array is behaving as a diverging lens.

4. An autostereoscopic display apparatus according to any one of the claims 1 to 3, wherein:
Said spatial light modulator is a liquid crystal display.

5. An autostereoscopic display according to any one of the claims 1 to 4, wherein:
Said lens array comprises of plurality of lenses at least one of which is a Fresnel lens.

6. An autostereoscopic display according to any one of the claims 1 to 4, wherein:
Said lens array comprises of plurality of lenses at least one of which is a diffraction lens.

7. An autostereoscopic display apparatus according to any one of the claims 1 to 6, wherein:
Said back lighting means is a collimated light source.

8. An autostereoscopic display apparatus according to any one of the claims 1 to 6, wherein:
Said back lighting means is a point light source.

9. An autostereoscopic display apparatus according to any one of the claims 1 to 6, wherein:
Said back lighting means is an array of point light sources.

10. An autostereoscopic display apparatus according to any one of the claims 1 to 6, wherein:
Said back lighting means is a light source that exhibits some diffuse light properties. The aperture screen is used as a device that selects only rays that have a predetermined direction on the surface of the special light modulator.

11. An autostereoscopic display apparatus according to any one of the claims 1 to 10, wherein:
the three-dimensional image information is color multiplexed. For instance the backlighting means may emanate red, green and blue light in a sequence and the spatial-light modulator modulates each color differently to create a color stereoscopic image.

12. An autostereoscopic display apparatus according to any one of the claims 1 to 11, wherein:
said spatial light modulator realizes a modulating photogram or a sequence of modulating photograms. The term “modulating photogram” as defined in the patent's description means a photographic or artificially generated record of an optical field in where the record consists of multiplicity of independent and non-overlapping minute, elemental images each of which is a projection of a large portion of the field.

13. An autostereoscopic display apparatus for displaying a subject in still or motion picture, said display comprising of:
a) An image projector or a collection of such. Said projectors emitting non-diffuse light wherein every ray has a predetermined direction at every point on the surface of the lens array. Effectively, this unites functionality of backlighting means together with the spatial light modulator of the claim 1.
b) A lens array comprising of plurality of elemental lenses.

14. An autostereoscopic display apparatus for displaying a subject in still or motion picture, said display comprising of:
a) An image projector or a collection of such. Said projectors emitting light that may be diffused. In order to maximize the effectiveness of the backlighting means the light should be non-diffuse light wherein every ray has a predetermined direction at every point on the surface of the lens array.
b) A lens array comprising of plurality of elemental lenses wherein every element of the lens array is behaving as a converging lens.
c) An aperture screen placed in front of the lens array. Said aperture screen comprising of an opaque material with plurality of apertures. Said apertures coincide with spots where the light emitted from the said light source is focused by each elemental lens of the lens array.

15. An autostereoscopic display apparatus according to any one of the claims 12 to 13, wherein:
said light emitting projectors are LCD projectors.

16. An autostereoscopic display according to any one of the claims 13 to 15 wherein:
said lens array comprises of plurality of lenses at least one of which is a Fresnel lens.

17. An autostereoscopic display according to any one of the claims 13 to 15, wherein:
said lens array comprises of plurality of lenses at least one of which is a diffraction lens.

18. An autostereoscopic display apparatus for displaying a subject in still or motion picture, said display comprising of an image projector or a collection of such wherein each projector emanates light with a predetermined directional distribution of light in intensity and color. Effectively, this unites functionality of backlighting means together with the spatial light modulator, lens array and the aperture screen of the claim 2.

19. An autostereoscopic display according to any one of the claims 13 to 17, wherein:
the three-dimensional image information is color multiplexed. For instance separate projectors could be used for presentation of different colors in the autostereoscopic image. For instance, one set of projectors could be used for red color, another for green and yet another for blue.

20. An autostereoscopic image capture and reproduction system similar to television, said system comprising of:
a) Three-dimensional image capture apparatus for capturing a three dimensional scene including light color and irradiance at all points of some window in space for all directions within a certain field of view. Such apparatus could be any of the integral photography cameras described in the prior art.
b) An autostereoscopic display apparatus according to any one of the claims 1 to 18.
c) A transmission system for transmitting information about a three-dimensional scene from said three-dimensional image capture apparatus to said autostereoscopic display.

21. An autostereoscopic image capture and reproduction system according to claim 19, wherein:
the information about the three-dimensional scene is stored in some form during the transmission process. This transmission may be completed later and the three-dimensional scene will be recreated on the autostereoscopic display.

22. An autostereoscopic image capture and reproduction system according to claim 19, wherein:
the information is transmitted by means of electromagnetic waves propagating in cables, waveguides or as airwaves.

23. An autostereoscopic display that comprises of several autostereoscopic displays according to any one of the claims 1 to 19 .

24. An autostereoscopic display according to claim 23 wherein:
the collection of elementary displays forms a surface that may not be flat and may enclose some volume in space. Such display can be used to show a three-dimensional scene from every direction.

25. An autostereoscopic display according to any one of the claims 1 to 19 wherein:
the outer surface is not flat and may enclose some volume in space. Such display can be used to show a three-dimensional scene from every direction.
